(19) United States
(12) Patent Application Publication
(10) Pub. No.: US 2025/0353021 A1
(43) Pub. Date: Nov. 20, 2025

(54) GAS JET SIEVE TRICHOME SEPARATION ASSEMBLY AND METHOD

(71) Applicant: MACH Technologies, Rochester Hills, MI (US)

(72) Inventors: Dylan Edward James Havey, Mussey, MI (US); Robert N. Wirtz, Royal Oak, MI (US)

(21) Appl. No.: 19/213,840

(22) Filed: May 20, 2025

Related U.S. Application Data
(60) Provisional application No. 63/649,591, filed on May 20, 2024.

(51) Int. Cl. B02C 19/00; B02C 19/06; B02C 19/18; B02C 23/08

(52) U.S. Cl. CPC B02C 19/0043; B02C 19/0056; B02C 19/068; B02C 19/186; B02C 23/08

(57) ABSTRACT

A gas jet sieve trichome separation assembly is employed in use to separate trichomes from source plant material, such as separating kief from cannabis source plant material. The gas jet sieve trichome separation assembly, as well as an associated method of its operation, serves to separate and collect trichomes in a manner that has proven more effective and efficient than past techniques, and in a manner that facilitates enhanced automation and that is intended for larger scale production capabilities. Per various implementations, the gas jet sieve trichome separation assembly has a housing, one or more sieves, one or more rotatable arms, one or more actuators, a vacuum source, and a cyclonic separator.

### CROSS-REFERENCE TO RELATED PATENT APPLICATION

This application claims the benefit of U.S. Provisional Patent Application No. 63/649,591, with a filing date of May 20, 2024.

### TECHNICAL FIELD

This disclosure relates generally to commercial agricultural production equipment and processes employable for plant biomass separation, and relates more specifically to commercial agricultural production equipment and processes for separating trichomes from plants.

### BACKGROUND

Certain plants, such as cannabis plants, have proven beneficial for medicinal purposes and, where laws permit, are consumed in various ways for recreational purposes. Trichomes, in general, are fine outgrowths or appendages or the like on plants. In cannabis plants, for instance, kief is a powder-like product emanating from resinous trichomes that form on cannabis flowers and leaves. When sifted from the flowers and leaves, the trichomes become kief. Kief is frequently considered the most valuable part of cannabis plants. Larger industrial and commercial scale production for effective and efficient collection of kief, as well as other types of trichomes, remains elusive.

### SUMMARY

In an embodiment, a gas jet sieve trichome separation assembly may include a housing, one or more sieves, one or more moveable arms, and a vacuum source. A chamber resides in the housing. The sieve(s) is located in the chamber and extends partly or more across an extent of the chamber. Source plant material can be loaded in the chamber at a first side of the chamber. The first side is defined relative to, and with respect to, the sieve(s). The moveable arm(s) is located within the chamber and is situated at a second side of the chamber. The second side is defined relative to, and with respect to, the sieve(s), and is opposite the first side. The moveable arm(s) extends partly or more across the extent of the chamber. The moveable arm(s) has one or more gas jet outlets that reside in its structure. The gas jet outlet(s) is directed at the sieve(s). The vacuum source communicates with the chamber at the second side of the chamber. Furthermore, amid operation of the gas jet sieve trichome separation assembly, a vacuum condition established by way of the vacuum source serves to draw the source plant material toward the sieve(s), and a gas jet provided by way of the moveable arm(s) and the gas jet outlet(s) serves to prompt movement of the source plant material at the first side and away from the sieve(s).

In an embodiment, a gas jet sieve trichome separation assembly may include a housing, one or more sieves, one or more rotatable arms, one or more actuators, a vacuum source. A chamber resides in the housing. The sieve(s) is located in the chamber. Source plant material can be loaded in the chamber at a first side of the chamber. The first side is defined relative to, and with respect to, the sieve(s). The rotatable arm(s) is located within the chamber and is situated at a second side of the chamber. The second side is defined relative to, and with respect to, the sieve(s), and is opposite the first side. The rotatable arm(s) has one or more gas jet outlets that reside in its structure. The gas jet outlet(s) is directed at the sieve(s). The actuator(s) is connected with the rotatable arm(s), and imparts rotational movement to the rotatable arm(s). The vacuum source communicates with the chamber at the second side of the chamber. The cyclonic separator is situated downstream of the housing, and is situated upstream of the vacuum source. The cyclonic separator communicates with the chamber at the second side of the chamber. Separated source plant material that passes through the sieve(s) is received by the cyclonic separator. Furthermore, amid operation of the gas jet sieve trichome separation assembly, a vacuum condition established by way of the vacuum source serves to draw the source plant material toward the sieve(s), and the rotatable arm(s) rotates about an axis thereof and propels a gas jet along substantially a full area of the sieve(s) at the chamber. The gas jet serves to prompt movement of substantially all of the source plant material drawn toward the sieve(s) away from the sieve(s).

In an embodiment, a method of separating trichomes from source plant material has a number of steps. One step may involve loading the source plant material within a chamber of a housing. Another step may involve providing one or more sieves at the chamber. The source plant material is loaded on one side of the sieve(s). Another step may involve subjecting the chamber to a vacuum condition. The source plant material is drawn against, and is drawn through, the sieve(s) by way of the vacuum condition. Another step may involve rotating the arm(s) at another side of the sieve(s). Yet another step may involve directing a gas jet from the arm(s) toward the sieve(s) while the arm(s) is in the midst of rotating. The gas jet serves to prompt movement of the source plant material in a direction generally away from the sieve(s). And a further step may involve removing separated source plant material from gas flow traveling downstream of the chamber and downstream of the sieve(s) by way of a cyclonic separator.

In an embodiment, a method of separating trichomes from source plant material has a number of steps. One step may involve loading the source plant material within a chamber of a housing. Another step may involve providing one or more sieves at the chamber. The source plant material is loaded on one side of the sieve(s). Another step may involve subjecting the chamber to a vacuum condition. The source plant material is drawn against, and is drawn through, the sieve(s) by way of the vacuum condition. Another step may involve vibrating the sieve(s). And a further step may involve removing separated source plant material from gas flow traveling downstream of the chamber and downstream of the sieve(s) by way of a cyclonic separator.

Further scope of applicability of the present disclosure will become apparent from the detailed description given hereinafter. But it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given below and the accompanying drawings, which are given by way of illustration only, and do not limit the present disclosure, and wherein:

FIG. 1 is a schematic depiction of an embodiment of a gas jet sieve trichome separation assembly;

FIG. 2 is a schematic depiction of another embodiment of the gas jet sieve trichome separation assembly;

FIG. 3 is a schematic depiction of another embodiment of the gas jet sieve trichome separation assembly;

FIG. 4 is a top view of an embodiment of a moveable arm showing a gas jet outlet thereof, the moveable arm for use with the gas jet sieve trichome separation assembly;

FIG. 5 illustrates another embodiment of the gas jet sieve trichome separation assembly;

FIG. 6 illustrates an embodiment of a moveable arm showing a gas jet outlet thereof, the moveable arm for use with the gas jet sieve trichome separation assembly;

FIG. 7 is an enlarged, magnified image of a sample of cannabis plant trichomes at input (left image) in an embodiment of the gas jet sieve trichome separation assembly, and subsequently as a resultant at output (right image) of the gas jet sieve trichome separation assembly;

FIG. 8 is a block diagram presenting an embodiment of a method of separating trichomes from source plant material;

FIG. 9 is a perspective view of an embodiment of a gas jet sieve trichome separation assembly;

FIG. 10 is another perspective view of an embodiment of the gas jet sieve trichome separation assembly of FIG. 9, with certain components exposed;

FIG. 11 is a front view of the gas jet sieve trichome separation assembly of FIG. 10;

FIG. 12 is a sectional view of the gas jet sieve trichome separation assembly of FIG. 10;

FIG. 13 is a perspective of the gas jet sieve trichome separation assembly of FIG. 9, showing additional components thereof;

FIG. 14 is a front view of the gas jet sieve trichome separation assembly of FIG. 13, with certain components exposed;

FIG. 15 is a sectional view of the gas jet sieve trichome separation assembly of FIG. 13; and

FIG. 16 is a sectional view of the gas jet sieve trichome separation assembly of FIG. 13.

### DETAILED DESCRIPTION

The drawings and descriptions present embodiments of a gas jet sieve trichome separation assembly 10-also called a rotary air jet sieve trichome separation assembly and a trichome separation system-and embodiments of a method of separating trichomes from source plant material. The trichome separation system is described as a kief refinement system per the embodiment herein, and the method of separating trichomes is described as a method of separating kief from cannabis source plant material per the embodiment herein; still, other trichomes from other source plant materials can be subject to the system and method set forth in this description in other embodiments. The gas jet sieve trichome separation assembly 10 and method serve to separate, refine, and collect kief in a manner that is more effective and more efficient than past techniques of collecting kief. Furthermore, as used herein, downstream refers to a direction in which cannabis source plant material is advanced through the gas jet sieve trichome separation assembly 10 from initial input to subsequent output, and upstream refers to a direction that is opposite the downstream direction. Still, a particular embodiment of the gas jet sieve trichome separation assembly and accompanying method may exhibit only one, or a combination of, the advancements set forth herein, none of the advancements, or other advancements not mentioned.

The gas jet sieve trichome separation assembly 10 can have different designs, constructions, and components in various embodiments, depending in part upon-among other possible factors-the desired quantity of cannabis source plant material to be subjected to kief refinement in a batch and the intended amount of kief to be collected from cannabis source plant material batches. In the embodiment of the figures, the gas jet sieve trichome separation assembly 10 is a machine and floor-standing equipment that includes a housing 12, one or more sieves 14, one or more rotatable arms 16, one or more actuators 18, a vacuum source 20, and a cyclonic separator 22; still, other embodiments of the gas jet sieve trichome separation assembly 10 can include more, less, and/or different components. These components are constituent parts that make-up the larger gas jet sieve trichome separation assembly 10.

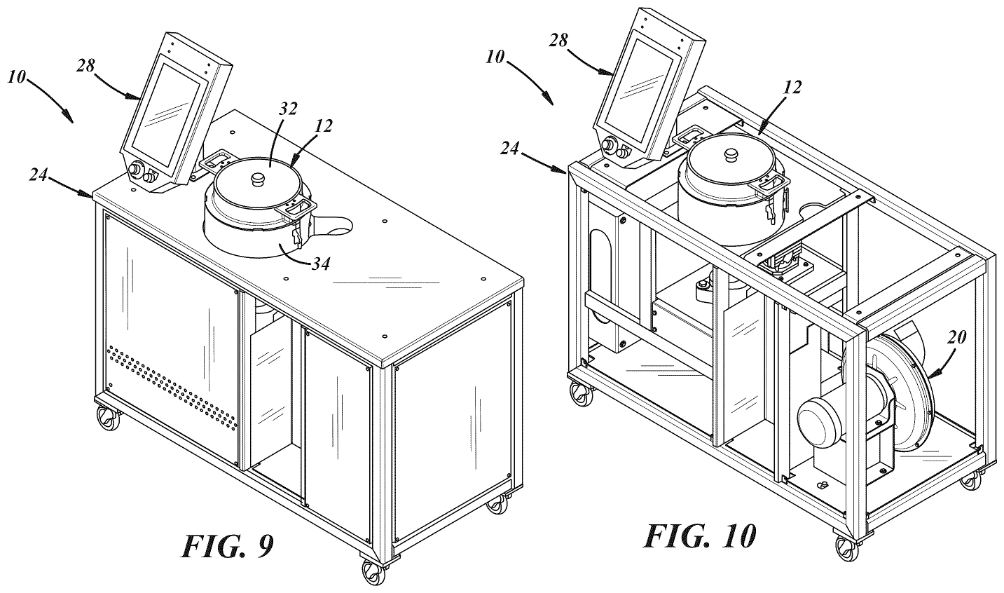

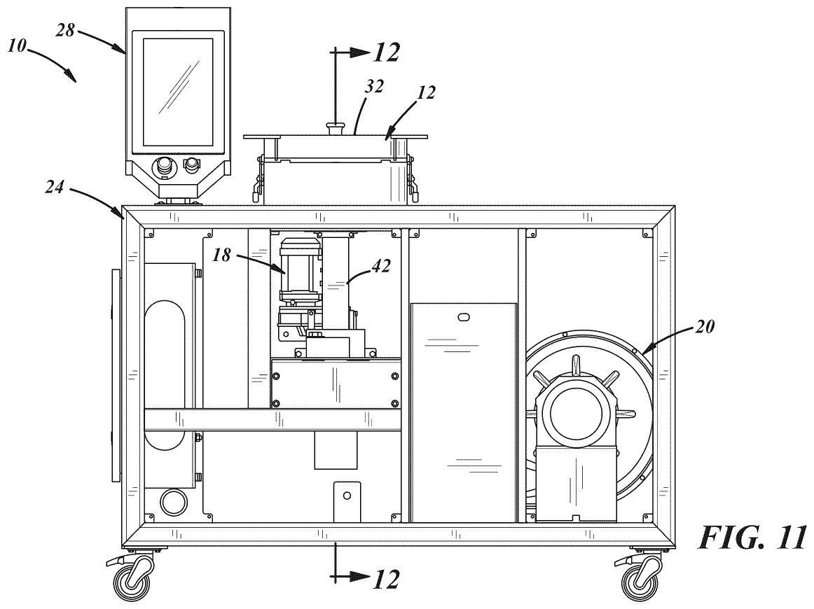

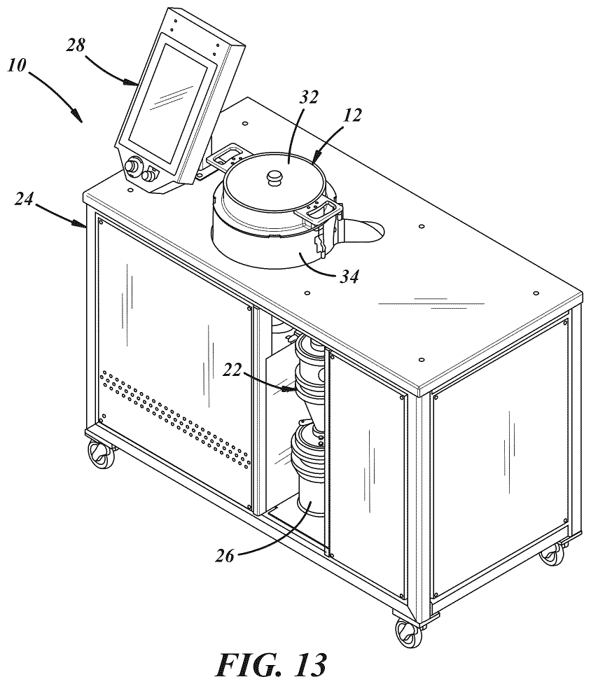

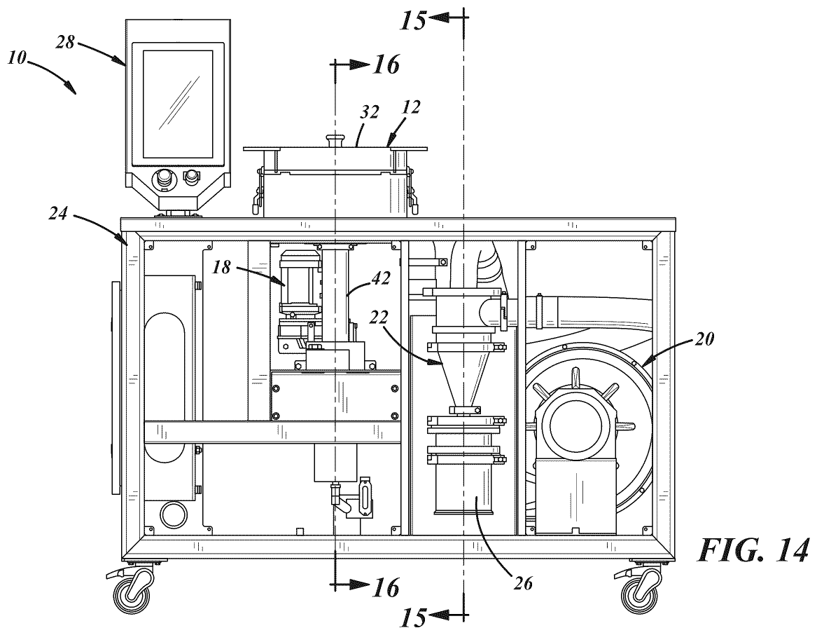

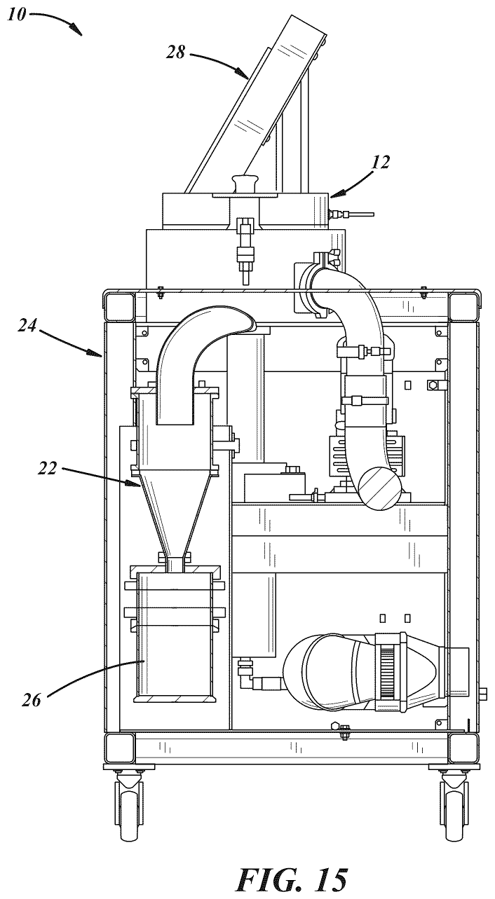

With reference now to the embodiment of FIGS. 9-16, a frame 24 provides a support structure for the components, and provides connections among the components for an integrated and whole machine. More generally, and with reference now generally to the figures, from initial loading and to subsequent collection and final collection, the general flow of migration and movement of the cannabis source plant material and separated trichomes in the gas jet sieve trichome separation assembly 10 involves movement from the housing 12 and to the cyclonic separator 22, where screened and separated kief is delivered in a collection tank 26 in fluid communication with the cyclonic separator 22. The cyclonic separator 22 is hence situated downstream of the housing 12. The vacuum source 20 is situated downstream of the cyclonic separator 22. Still, the gas jet sieve trichome separation assembly 10 can have more, less, and/or different components in various embodiments; for example, a human-machine-interface (HMI) 28 could be provided for operator management of the gas jet sieve trichome separation assembly 10, and a controller such as a programmable logic controller (PLC) could be provided for control and automation of the multiple components and stages of the gas jet sieve trichome separation assembly 10, as well as for control of certain parameters of the discrete components and stages.

The housing 12 establishes a chamber 30 that resides therein. The chamber 30 accepts and receives the source plant material subject to separation and refinement in the gas jet sieve trichome separation assembly 10. The chamber 30 can be divided into a first side FS and a second side SS. The first and second sides FS, SS are established with respect to the sieve(s) 14 which partitions the chamber 30. According to the embodiment of the figures, the first side FS is an upper side of the chamber 30, and the second side SS is a lower side of the chamber 30. The first and second sides FS, SS are opposite relative to each other. The source plant material can be loaded in the housing 12 and in the chamber 30 at the first side FS thereof. A lid 32 of the housing 12 can be opened and closed by a user for access to and sealing of the chamber 30 during use of the gas jet sieve trichome separation assembly 10. A multitude of walls 34 make-up the housing 12. During use of the gas jet sieve trichome separation assembly 10, when propelled via gas jet, the source plant material can come into collision with an internal surface of the chamber 30 and of the walls 34; it has been found that such collisions, should they occur, serve to facilitate separation and refinement capabilities of the trichomes from the source plant material. The chamber 30 can have a bowl-like shape.

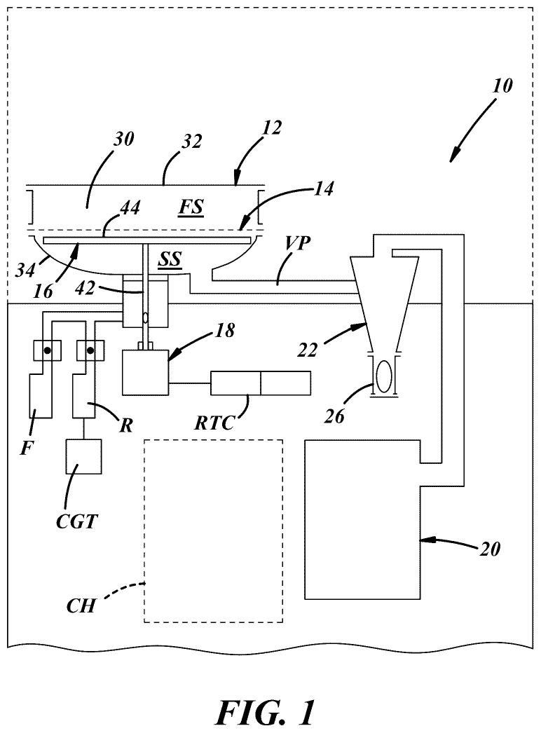

Furthermore, per certain embodiments, it has been found that bringing the source plant material (e.g., cannabis source plant material) to a cooled or even frozen state and largely or wholly maintaining that state in the gas jet sieve trichome separation assembly 10 and method can augment the effectiveness and efficiencies of trichome separation, collection, and refinement. The cooled source plant material has been shown-under certain circumstances and in certain embodiments - to be more readily sieved and screened in the gas jet sieve trichome separation assembly 10 and method, and can facilitate its handling and movement in the gas jet sieve trichome separation assembly 10. In this regard, and with reference to the embodiment of FIG. 3, one or a multitude of coolant passages 36 can reside within and throughout the walls 34 of the housing 12, as well as within and throughout other pathways of the gas jet sieve trichome separation assembly 10. A coolant inlet CI provides entry of coolant fluid-flow without the coolant passages 36, and a coolant outlet CO provides exit of the coolant fluid-flow. A chiller CH (FIG. 1) can be provided for the coolant fluid-flow. Still, other ways of providing a cooled state of the source plant material are possible in other embodiments. In the embodiment of FIG. 1, for example, the gas jet sieve trichome separation assembly 10 can be located within a humidity and temperature-controlled environment. Per various embodiments, a temperature of the chamber 30 at the first side FS can be brought to and/or maintained within a range of 20° C. and −196° C., inclusive of values therein and therebetween. In a further embodiment, a liquid nitrogen (LN₂) can be introduced and circulated within the walls 34 of the housing 12 for this purpose; here, solenoid valves can be equipped at the housing 12 for controlling introduction and circulation, along with timing circuits; further, temperature sensors (e.g., infrared, conductive, etc.) can be provided for sensing temperatures within the chamber 30 and control purposes thereof.

The sieve(s) 14 serves as a means of separation and refinement of trichomes from the source plant material. The sieve(s) 14 can take various forms in various embodiments, and can come in various quantities. In the embodiment of the figures, the sieve(s) 14 is a single sieve; but other embodiments could include more than one sieve arranged in series one after another, such as a first sieve having sieve openings of a first size and a second sieve having sieve openings of a second size that is less than that of the first size. In the embodiment of the figures, the sieve 14 is located within the chamber 30 and has a planar configuration. The sieve 14 extends wholly across a full extent of the chamber 30, whereby source plant material and trichomes can only make their way to the second side SS via passing through the sieve 14. The sieve 14 can have a location within the chamber 30 that is upstream of the rotatable arm(s) 16 and, according to this embodiment, vertically above the rotatable arm(s) 16. The sieve 14 has numerous sieve openings. The size of the sieve openings can be dictated by the degree of trichome separation and refinement desired of the gas jet sieve trichome separation assembly 10. In various embodiments, the sieve openings can exhibit a pore size that ranges between approximately 10 micrometers (μm) and 300 μm, inclusive of values therein and therebetween.

The rotatable arm(s) 16, or moveable arm, propels and ejects a gas jet directed at the sieve 14 amid use of the gas jet sieve trichome separation assembly 10 in order to prompt movement of the source plant material residing at the sieve 14 and to further cause movement of the source plant material within the chamber 30 at the first side FS. The source plant material is moved upward and away from the sieve 14 via the gas jet. Dislodgement and unclogging of the sieve 14 can occur via the rotatable arm(s) 16 and the gas jet. The rotatable arm(s) 16 can take various forms in various embodiments, and can come in various quantities. In the embodiment of the figures, the rotatable arm(s) 16 is a single rotatable arm 16; but other embodiments could include more than one rotatable arm. In the embodiment of the figures, components of the rotatable arm 16 are located within the chamber 30 and are situated at the second side SS of the chamber 30. The rotatable arm 16 is driven to move and rotate via the actuator(s) 18. In the embodiment here, the rotatable arm 16 rotates and spins about an axis 40 during operation of the gas jet sieve trichome separation assembly 10.

The rotatable arm 16 can have various components in various embodiments. In the embodiment of the figures, the rotatable arm 16 has a shaft 42 and a bar or blade 44. The shaft 42 has a connection with the actuator 18, and the blade 44 extends from the shaft 42 at an orthogonal configuration. The shaft 42 can be a tube-like and hollow structure. The shaft 42 extends exterior of the chamber 30 and housing 12. The blade 44 is located within the chamber 30 and positioned therein via the shaft 42, and moves and rotates therein. The blade 44 can be a tube-like and hollow structure. The blade 44 can extend partly or more across the extent of the chamber 30, and can extend wholly across the full extent of the chamber 30 and wholly across a full extent of the sieve 14. Furthermore, a gas jet outlet 38 is defined and resides within the blade 44. The gas jet outlet 38 can take various forms in various embodiments, and can come in various quantities. In the embodiment of the figures, the gas jet outlet 38 is a single and continuous slot-like opening defined in the blade 44. The gas jet outlet 38 is positioned at an upper end of the blade 44 so that it is directed at the sieve 14 and directly beneath the sieve 14. The gas jet outlet 38 spans a majority and substantially the full longitudinal and lengthwise extent of the blade 44. The gas jet is propelled and ejected out of the gas jet outlet 38 during use of the gas jet sieve trichome separation assembly 10, and as the rotatable arm 16 is driven to rotate. The propelled gas jet is hence continually and recurringly moved and swept across the sieve 14 in a circumferential sweeping motion. The propelled gas jet can cover a full area of the sieve 14 so that all or substantially all of the source plant material is prompted to move away from the sieve 14. The source plant material is recurringly prompted to move away from the sieve 14 via the propelled gas jet, before being drawn back toward the sieve 14 via the vacuum source 20. The gas jet is propelled and the rotatable arm 16 is rotated simultaneously with activation of the vacuum source 20 at the chamber 30. The propelled gas jet can be composed of atmospheric air and/or compressed gas. The compressed gas can be compressed nitrogen gas, compressed argon gas, or compressed carbon dioxide, among other possibilities.

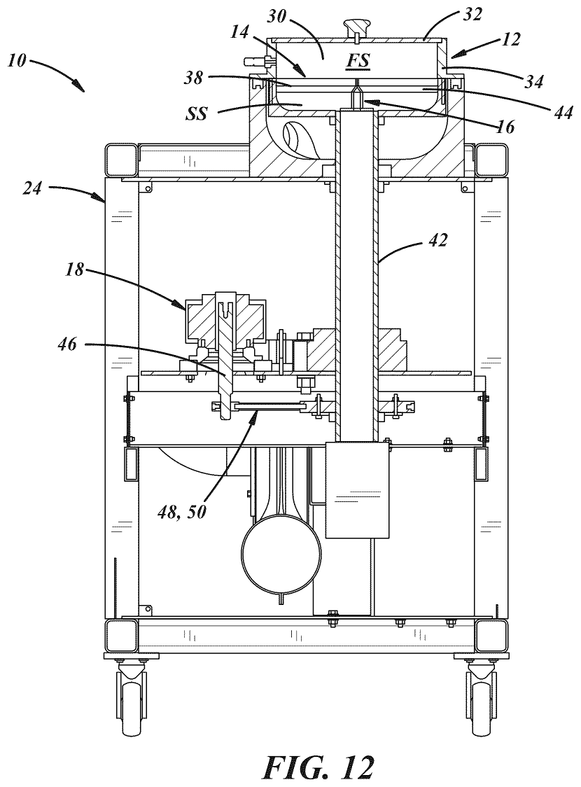

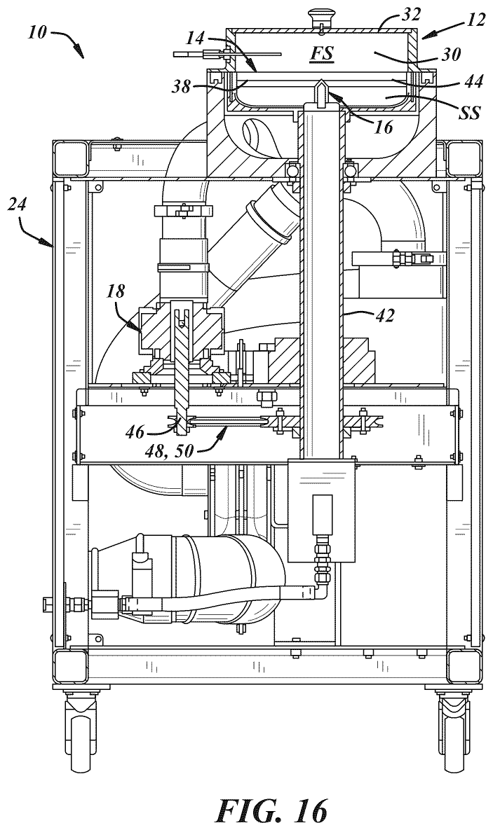

The actuator(s) 18 drives rotational movement of the rotatable arm(s) 16. Upon its actuation, the actuator(s) 18 imparts rotations movement to the rotatable arm(s) 16. The actuator(s) 18 can take various forms in various embodiments, and can come in various quantities. In the embodiment of the figures, the actuator(s) 18 is a single actuator 18. The actuator 18 can be in the form of an electric type of motor and can be a gearmotor; still, other types of actuators and motors are possible. In the embodiment of the figures, a connection can extend between the actuator 18 and the rotatable arm(s) 16. In the embodiment of FIGS. 12 and 16, for example, a motor shaft 46 of the actuator 18 is connected with the shaft 42 via a mechanical linkage 48. The mechanical linkage 48, per this embodiment, is in the form of a rotor shaft pulley assembly 50.

The vacuum source 20 imparts a vacuum condition within the housing 12 and within the chamber 30 during operation of the gas jet sieve trichome separation assembly 10 that serves to draw the source plant material toward and against the sieve(s) 14. The vacuum source 20 can take various forms in various embodiments. In relation to other components of the gas jet sieve trichome separation assembly 10, the vacuum source 20 is located downstream of the housing 12, downstream of the chamber 30, downstream of the sieve(s) 14, and downstream of the cyclonic separator 22. The vacuum source 20 has fluid communication with the cyclonic separator 22 via tubing, and has fluid communication with the chamber 30 at the second side SS of the chamber 30 via tubing. In the embodiment of the figures, the vacuum source 20 is in the form of a blower providing suction to the chamber 30.

The cyclonic separator 22 serves to remove separated trichomes downstream of the chamber 30 via vortex separation during operation of the gas jet sieve trichome separation assembly 10. The removed trichomes can be delivered to the collection tank 26. The cyclonic separator 22 can take various forms in various embodiments. In relation to other components of the gas jet sieve trichome separation assembly 10, the cyclonic separator 22 is located downstream of the housing 12, downstream of the chamber 30, downstream of the sieve(s) 14, and upstream of the vacuum source 20. The cyclonic separator 22 has fluid communication with the chamber 30 at the second side SS of the chamber 30 via tubing.

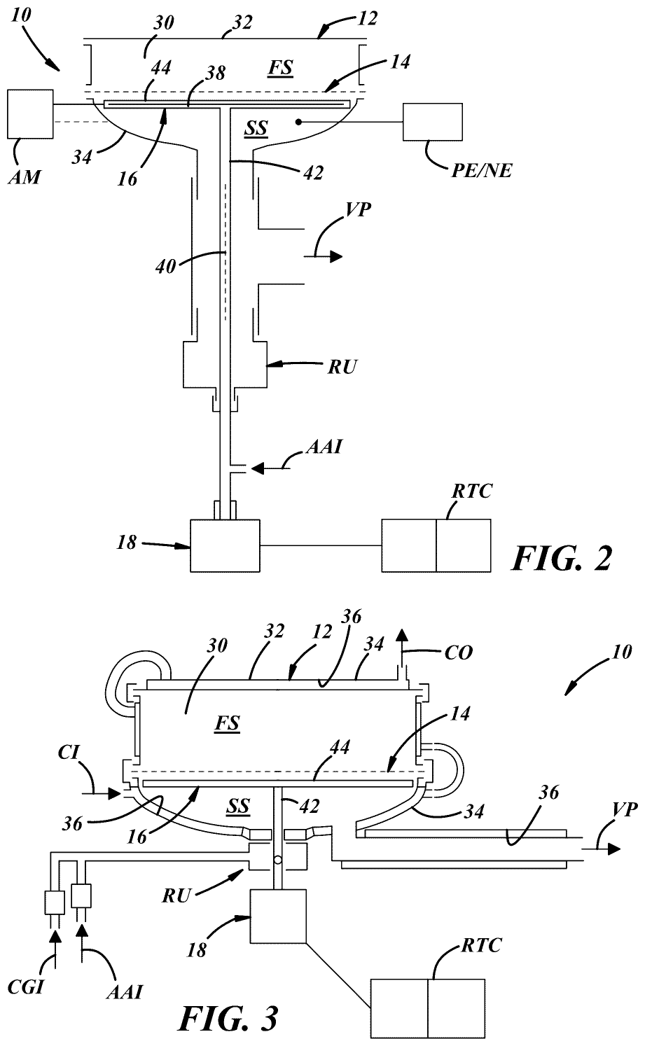

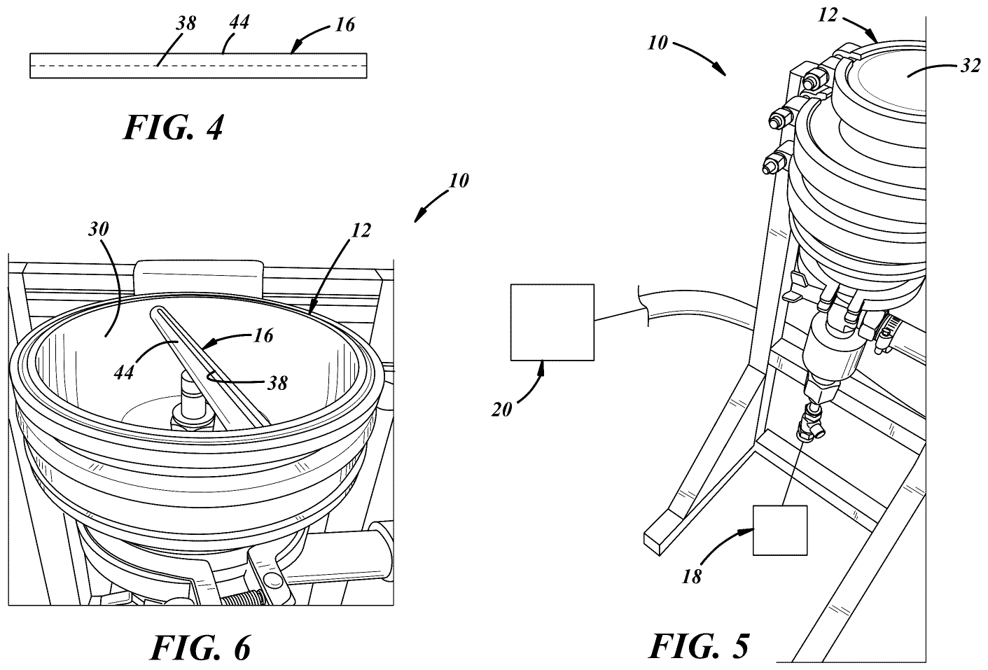

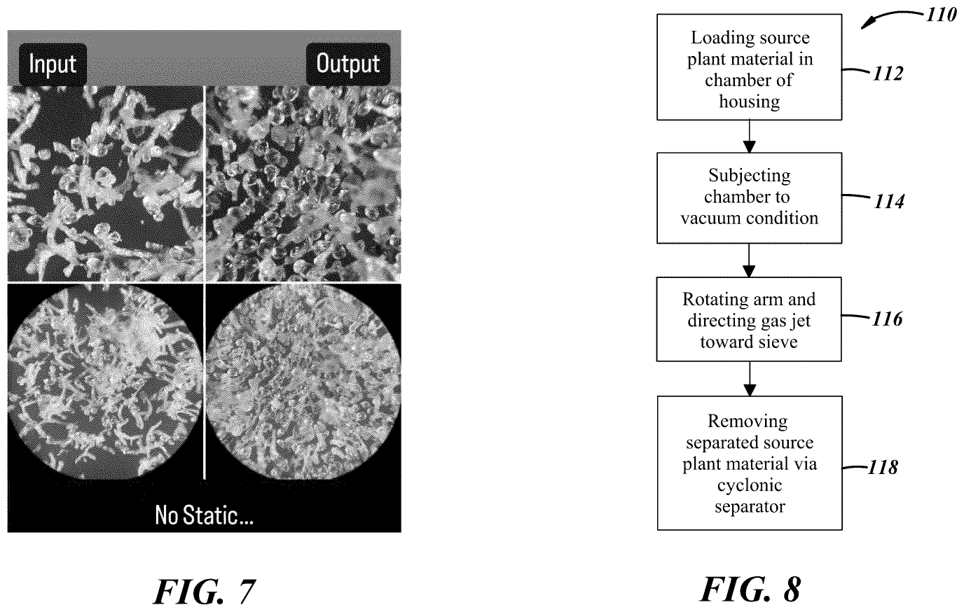

Still further, various embodiments of the gas jet sieve trichome separation assembly 10 can include other components, including but not limited to: a filter F (FIG. 1), a regulator R (FIG. 1), a compressed gas tank CGT (FIG. 1) for holding a compressed gas (e.g., compressed nitrogen gas, compressed argon gas, or compressed carbon dioxide, among other possibilities), an RPM and timer controller RTC (FIGS. 1, 2, and 3), a vacuum path VP (FIGS. 2 and 3) leading to the cyclonic separator 22, a rotary union RU (FIGS. 2 and 3) to facilitate rotation of the rotatable arm(s) 16, an atmospheric air inlet AAI (FIGS. 2 and 3), and a compressed gas inlet CGI (FIG. 3).

FIG. 8 is a block diagram that presents an embodiment of a method 110 of separating kief (or other trichomes) from cannabis source plant material (or other source plant material). The method 110 involves several steps that are performed in successive stages. More, less, and/or different steps can be performed in other embodiments of the method 110 of separating kief from cannabis source plant material than will be described with reference to FIG. 8. The method 110 can be performed with the gas jet sieve trichome separation assembly 10 according to this embodiment. In a step 112, source plant material is loaded within the chamber 30 of the housing 12. Another step involves providing the sieve(s) 14 at the chamber 14. In a step 114, the chamber 30 is subjected to the vacuum condition, and the source plant material is hence drawn against and through the sieve(s) 14. In a step 116, the rotatable arm(s) 16 is rotated. Another step involves directing the gas jet toward the sieve(s) 14. In a step 118, separated source plant material is removed from gas flow traveling downstream of the chamber 30 and downstream of the sieve(s) 14. The separated source plant material is removed via the cyclonic separator 22. Still, other steps can involve one or more of the following: i) concurrently drawing some or more of the source plant material toward the sieve(s) 14 via the vacuum source 20 and rotating the rotatable arm(s) 16; and/or ii) bringing the source plant material to its cooled state.

In an embodiment, a further step of the method 110 of separating kief (or other trichomes) from cannabis source plant material (or other source plant material)—and hence another embodiment of the gas jet sieve trichome separation assembly 10—may involve situating a positive electrode PE (e.g., anode or cathode electrode), situating a negative electrode NE (e.g., cathode or anode electrode), or situating both the positive electrode PE and negative electrode NE at, adjacent, and/or downstream of the sieve(s) 14 (while the positive and negative electrodes PE, NE are shown schematically in FIG. 2, the embodiment of the positive and negative electrodes PE, NE can be implemented in any of the embodiments set forth herein). The positive and/or negative electrodes PE, NE can be disposed on the lid 32, on the sieve(s) 14, on the housing 12, and/or another location. A yet further step may involve providing a positive electrical charge or a negative electrical charge to some or more of the source plant material for attraction to the respective positive electrode PE or negative electrode NE. The positive and/or negative electrodes PE, NE can provide an electrostatic attraction or repulsion force that can influence behavior of particles of the source plant material at different stages of operation of the gas jet sieve trichome separation assembly 10 and of the method 110 of separating kief (or other trichomes) from cannabis source plant material (or other source plant material). As an example, separated source plant material that passes through the pore size of the sieve(s) 14 can include trichomes and unwanted impurities of similar sizes. In order to further remove the impurities, the impurities can be provided with an electrical charge that will be drawn and pulled toward the positive or negative electrode PE, NE, permitting the trichomes to continue movement downstream without the impurities. Still, other examples uses are possible.

In an embodiment, a further step of the method 110 of separating kief (or other trichomes) from cannabis source plant material (or other source plant material)—and hence another embodiment of the gas jet sieve trichome separation assembly 10—may involve agitating via vibrating the sieve(s) 14. The agitation and/or vibration can be imparted per this embodiment via an agitation mechanism AM (while the agitation mechanism AM is shown schematically in FIG. 2, the embodiment of the agitation mechanism AM can be implemented in any of the embodiments set forth herein). A yet further step may involve agitating via vibrating the housing 12. The agitation mechanism AM could take various forms in different embodiments. Depending on its form, the agitation mechanism AM could impart various kinds of forcible agitation and movement to the ground and cooled cannabis source plant material including, but not limited to, vibratory motion, gyratory motion, reciprocal motion, and oscillating motion. In at some of its forms, the agitation mechanism AM could include an agitation motor. In an embodiment, an ultrasonic transducer could be connected to the sieve(s) 14 and could be activated to emit ultrasonic vibrations to the sieve(s) 14 in order to deblind the sieve(s) 14. Furthermore, in embodiments of the gas jet sieve trichome separation assembly 10 with the agitation and/or vibration, the rotatable arm(s) 16 and accompanying gas jet need not necessarily be provided and can be absent.

In an embodiment, one or more rotating brushes can be provided and equipped within the housing 12 and within the chamber 30 for the purpose of removed adhered source plant material from the inside of the walls 34, lid 32, and/or sieve(s) 14. Movement and rotation of the brush(es) can be imparted via an actuator like the previously-described actuator 18; here, the brush actuator could be mounted at the housing 12 such as atop the lid 32. Still, movement and rotation of the brush(es) could be imparted manually by an operator. The brush(es) can be composed of an insulative or conductive material, depending on the embodiment, and can be electrically charged, grounded, and/or neutral.

In an embodiment, a digital microscope or vision-based imaging apparatus can be provided and equipped at the gas jet sieve trichome separation assembly 10. Here, the digital microscope or vision-based imaging apparatus could be employed to observe the source plant material amid separation and/or refinement and/or drying. The digital microscope or vision-based imaging apparatus could communicate with software logic on an electronic controller to assess and detect the presence of contaminants with the source plant material and/or the degree of separation and/or refinement. The logic could be programmed to adjust one or more process control variables of the gas jet sieve trichome separation assembly 10 in real-time based on the observations.

Per various embodiments, and as described, the gas jet sieve trichome separation assembly 10 is a particle separator used to refine powders and small plant particulates into fractions using different size sieve screens. This separation is driven by the principle that particles smaller than the pore size of the sieve can penetrate through the sieve structure, while particles larger than the pore size are excluded and remain on the sieve surface. The smaller particles drawn into the vacuum path are collected in a cyclonic separator to create two distinct fractions. Multiple sieves can be used together to separate material into more fractions if desired.

Per various embodiments, and as described, the sieve is used to refine cannabis plant particles by size, allowing the operator to target a fraction primarily containing glandular trichome heads from the female cannabis plant flowers. The trichome head is the highest concentration of cannabinoids on the plant, allowing operators to concentrate cannabinoid purity with mechanical separation. This mechanical separation allows for easier storage and extraction of cannabinoids from the plant.

Per various embodiments: Rotary air jet screen deblinding—The particle sample inside the gas jet sieve trichome separation assembly 10 sample chamber lays directly on a flat sieve with pore sizes that can range between 10-300 microns. As a vacuum is pulled on the bottom of the sieve the input sample is pulled against the flat surface. In order to deblind and create a consistent flow of air through the system an inlet port allows air to travel through the rotating arm that sits directly below the filter screen. Positive pressure with the use of a compressed gas can be in conjunction with a vacuum. The rotor has a small cut along the entire top surface to allow the air to create a jet stream or line of air that has enough velocity to shoot the air through the sieve, pushing the sample into the headspace of the sample chamber and colliding with the walls/top of the sample chamber assisting in dispersion and deagglomeration. The rotating air inlet constantly clears the sieve allowing the airborne particles to then be drawn to the clear sieve surface available, pulling through smaller particles. The rotor speed and cycle time can be set by a controller on the motor.

Adjustable system parameters, per various embodiments, may involve: sieve size (10-300 microns), vacuum CFM (10-2000 cfm), rotor speed (10-300 rpm), rotor air inlet size (0.5 mm-3 mm), sample chamber and system temperature (−196° C. to 30° C. with use of a chiller, liquid nitrogen, liquid CO2, or similar method or environment for temperature controlled process), use of a passive atmospheric air return or regulated compressed gas (nitrogen, argon, carbon dioxide (CO2), air, etc.), humidity of incoming air/ambient environment, and rotor type (single side rotor, full diameter rotor, cross rotor, six arm rotor, etc.). The sieve can be in the form of various types of screens including, but not limited to, a single mesh, double mesh, square openings in mesh, rectangular openings in mesh, and/or circular openings in mesh; the precise form of the sieve can be dictated by the particular process parameters and desired outcomes.

A process of operation, per varying embodiments, may involve: 1) set system parameter before loading sample; 2) load mixed plant material into sample spool directly above the filter and secure lid; 3) turn on the vacuum which will immediately pull all the plant material flat against the filter; 4) open the solenoid to allow air to be drawn through the filter and into the sieve. The incoming air passes through the rotary union and into the rotor air inlet bar. A single line will appear on the screen as the incoming air creates an upward force deblinding the small portion of the sieve directly above the rotor; and 5) smaller particles will be collected in the cyclonic separate before the vacuum pump creating two fractions.

A process of operation with cannabis, per varying embodiments, may involve: 1) select system parameters. Ex. 250 micron sieve size, 100 cfm vacuum, 60 rpm, 0.5 mm air inlet, −40c system temperature, passive air supply. 40% Relative Humidity in the chamber; 2) place milled cannabis plant material into the sample chamber resting on the screen; 3) allow the system to run for 30 minutes, pulling smaller particles into the cyclonic separator; 4) after the run is complete, empty the sample chamber and cyclonic collection then clean with a brush; 5) replace the 250 micron sieve with a 70 micron sieve; 6) load the sample that was collected in the cyclonic separator; 7) seal the system and run for an additional 30 minutes; and 8) now the sample that remains inside the sample chamber will have a particle size ranging between 71microns to 249 microns. Additional screens and refinement can be employed to separate samples into smaller fractions.

In general, while a multitude of embodiments have been depicted and described with a multitude of components in each embodiment, in alternative embodiments of the rotary air jet sieve assembly and accompanying method the components and steps of various embodiments could be intermixed, combined, and/or exchanged for one another. In other words, components described in connection with a particular embodiment are not necessarily exclusive to that particular embodiment.

As used herein, the terms “general,” “generally,” “approximately,” and “substantially” are intended to account for the inherent degree of variance and imprecision that is often attributed to, and often accompanies, any design and manufacturing process and measurement, including engineering tolerances, and without deviation from the relevant functionality and intended outcome, such that mathematical precision and exactitude is not implied and, in some instances, is not strictly possible. In other instances, the terms “general,” “generally,” “approximately,” and “substantially” are intended to represent the inherent degree of uncertainty that is often attributed to any quantitative comparison, value, and measurement calculation, or other representation, such that mathematical precision and exactitude is not implied and, in some instances, is not strictly possible.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

Those of skill in the art will understand that modifications (additions and/or removals) of various components of the substances, formulations, apparatuses, methods, systems, and embodiments described herein may be made without departing from the full scope and spirit of the present disclosure, which encompass such modifications and any and all equivalents thereof.

1. A gas jet sieve trichome separation assembly, the assembly comprising:
a housing, a chamber residing in said housing;
at least one sieve located in said chamber and extending at least partly across an extent of said chamber, source plant material loadable in said chamber at a first side of said chamber with respect to said at least one sieve;
at least one moveable arm located within said chamber and situated at a second side of said chamber with respect to said at least one sieve, said second side being opposite said first side, said at least one moveable arm extending at least partly across the extent of said chamber, said at least one moveable arm having at least one gas jet outlet residing therein, said at least one gas jet outlet directed at said at least one sieve; and
a vacuum source communicable with said chamber at said second side of said chamber;
wherein, during operation of the gas jet sieve trichome separation assembly, a vacuum condition via said vacuum source draws the source plant material toward said at least one sieve and a gas jet via said at least one moveable arm and via said at least one gas jet outlet prompts movement of the source plant material at said first side and away from said at least one sieve.

2. The gas jet sieve trichome separation assembly as set forth in claim 1, wherein, during operation of the gas jet sieve trichome separation assembly, said at least one moveable arm moves along said at least one sieve and sweeps said gas jet along said at least one sieve and recurringly prompts movement of the source plant material away from said at least one sieve while said vacuum condition simultaneously draws the source plant material toward said at least one sieve.

3. The gas jet sieve trichome separation assembly as set forth in claim 1, wherein said at least one sieve extends wholly across the full extent of said chamber, and said at least one moveable arm extends substantially across the full extent of said chamber.

4. The gas jet sieve trichome separation assembly as set forth in claim 3, wherein said at least one gas jet outlet spans substantially across the full extent of said at least one moveable arm.

5. The gas jet sieve trichome separation assembly as set forth in claim 1, wherein said at least one moveable arm is an at least one rotatable arm, and wherein during operation of the gas jet sieve trichome separation assembly, said at least one rotatable arm rotates about an axis thereof and propels said gas jet along substantially a full area of said at least one sieve at said chamber for prompting movement of substantially all of the source plant material drawn toward said at least one sieve.

6. The gas jet sieve trichome separation assembly as set forth in claim 1, wherein, during operation of the gas jet sieve trichome separation assembly, said gas jet propels movement of at least some of the source plant material in collision with a wall of said housing at said first side of said chamber.

7. The gas jet sieve trichome separation assembly as set forth in claim 1, wherein said gas jet comprises atmospheric air, compressed gas, or both atmospheric air and compressed gas.

8. The gas jet sieve trichome separation assembly as set forth in claim 1, wherein said gas jet comprises a compressed gas, said compressed gas being a compressed nitrogen gas, a compressed argon gas, or a compressed carbon dioxide gas.

9. The gas jet sieve trichome separation assembly as set forth in claim 1, wherein said at least one sieve has a plurality of sieve openings residing therein, said plurality of sieve openings exhibiting a size that ranges between approximately 10 micrometers (μm) and 300 micrometers (μm).

10. The gas jet sieve trichome separation assembly as set forth in claim 1, further comprising an actuator connected with said at least one moveable arm and actuated in order to impart movement of said at least one moveable arm.

11. The gas jet sieve trichome separation assembly as set forth in claim 1, further comprising a cyclonic separator situated downstream of said housing and situated upstream of said vacuum source, said cyclonic separator communicable with said chamber at said second side of said chamber and receiving source plant material that passes through said at least one sieve.

12. The gas jet sieve trichome separation assembly as set forth in claim 1, wherein said housing has at least one wall with at least one coolant passage residing therein, said at least one wall at least partly establishing said chamber, and wherein, during operation of the gas jet sieve trichome separation assembly, coolant fluid-flow travels through said at least one coolant passage in order to bring the source plant material to a cooled state.

13. A gas jet sieve trichome separation assembly, the assembly comprising:
a housing, a chamber residing in said housing;
at least one sieve located in said chamber, source plant material loadable in said chamber at a first side of said chamber with respect to said at least one sieve;
at least one rotatable arm located within said chamber and situated at a second side of said chamber with respect to said at least one sieve, said second side being opposite said first side, said at least one rotatable arm having at least one gas jet outlet residing therein, said at least one gas jet outlet directed at said at least one sieve;
at least one actuator connected with said at least one rotatable arm and imparting rotational movement to said at least one rotatable arm;
a vacuum source communicable with said chamber at said second side of said chamber; and
a cyclonic separator situated downstream of said housing and situated upstream of said vacuum source, said cyclonic separator communicable with said chamber at said second side of said chamber and receiving separated source plant material that passes through said at least one sieve;
wherein, during operation of the gas jet sieve trichome separation assembly, a vacuum condition via said vacuum source draws the source plant material toward said at least one sieve and said at least one rotatable arm rotates about an axis thereof and propels a gas jet along substantially a full area of said at least one sieve at said chamber for prompting movement of substantially all of the source plant material drawn toward said at least one sieve away from said at least one sieve.

14. The gas jet sieve trichome separation assembly as set forth in claim 13, wherein, during operation of the gas jet sieve trichome separation assembly, said at least one rotatable arm recurringly prompts movement of the source plant material away from said at least one sieve while said vacuum condition simultaneously draws the source plant material toward said at least one sieve.

15. The gas jet sieve trichome separation assembly as set forth in claim 13, wherein said at least one sieve extends wholly across a full extent of said chamber, and said at least one rotatable arm extends substantially across the full extent of said chamber.

16. The gas jet sieve trichome separation assembly as set forth in claim 13, wherein said housing has at least one wall with at least one coolant passage residing therein, said at least one wall at least partly establishing said chamber, and wherein, during operation of the gas jet sieve trichome separation assembly, coolant fluid-flow travels through said at least one coolant passage in order to bring the source plant material to a cooled state.

17. A method of separating trichomes from source plant material, the method comprising:
loading the source plant material within a chamber of a housing, and providing at least one sieve at said chamber, the source plant material loaded on one side of said at least one sieve;
subjecting said chamber to a vacuum condition, the source plant material being drawn against and through said at least one sieve via said vacuum condition;
rotating at least one arm at another side of said at least one sieve, and directing a gas jet from said at least one arm toward said at least one sieve while said at least one arm is rotating, said gas jet prompting movement of the source plant material away from said at least one sieve; and
removing separated source plant material from gas flow traveling downstream of said chamber and downstream of said at least one sieve via a cyclonic separator.

18. The method of separating trichomes from source plant material as set forth in claim 17, further comprising concurrently drawing at least some of the source plant material toward said at least one sieve via said vacuum source and rotating said at least one arm and recurringly directing said gas jet toward said at least one sieve and hence recurringly prompting movement of at least other of the source plant material away from said at least one sieve.

19. The method of separating trichomes from source plant material as set forth in claim 17, further comprising bringing the source plant material to a cooled state amid subjecting said chamber to said vacuum condition and amid directing said gas jet toward said at least one sieve.

20. The method of separating trichomes from source plant material as set forth in claim 17, further comprising:
situating a positive electrode, a negative electrode, or both a positive electrode and a negative electrode downstream of said at least one sieve; and
providing a positive electrical charge or a negative electrical charge to some of the source plant material for attraction to said positive electrode or to said negative electrode.

21. A method of separating trichomes from source plant material, the method comprising:
loading the source plant material within a chamber of a housing, and providing at least one sieve at said chamber, the source plant material loaded on one side of said at least one sieve;
subjecting said chamber to a vacuum condition, the source plant material being drawn against and through said at least one sieve via said vacuum condition;
vibrating said at least one sieve; and
removing separated source plant material from gas flow traveling downstream of said chamber and downstream of said at least one sieve via a cyclonic separator.

22. The method of separating trichomes from source plant material as set forth in claim 21, further comprising vibrating said housing.

23. The method of separating trichomes from source plant material as set forth in claim 21, further comprising:
situating a positive electrode, a negative electrode, or both a positive electrode and a negative electrode downstream of said at least one sieve; and
providing a positive electrical charge or a negative electrical charge to some of the source plant material for attraction to said positive electrode or to said negative electrode.
